(19) United States
(12) Patent Application Publication
(10) Pub. No.: US 2017/0050473 A1
(43) Pub. Date: Feb. 23, 2017

(54) TIRE COMPRISING A HIGH CONTRAST MATRIX SYMBOL ON THE SIDEWALL THEREOF

(71) Applicants: COMPAGNIE GENERALE DES ETABLISSEMENTS MICHELIN, Clermont-Ferrand (FR); Michelin Recherche et Technique S.A., Granges-Paccot (CH)

(72) Inventors: Olivier MUHLHOFF, Clermont-Ferrand Cedex 9 (FR); Jean-Claude DESVIGNES, Clermont-Ferrand Cedex 9 (FR)

(21) Appl. No.: 15/307,954

(22) PCT Filed: Apr. 28, 2015
(86) PCT No.: PCT/EP2015/059122

§ 371 Date: Oct. 31, 2016

(30) Foreign Application Priority Data
Apr. 30, 2014 (FR) 1453987

(51) Int. Cl. B60C 13/00

(52) U.S. Cl. CPC B60C 13/001

(57) ABSTRACT

A tire made of rubbery material comprising a sidewall (3). The sidewall (3) comprises at least one coded matrix symbol (4), the coded matrix symbol (4) comprising dark parts and light parts, the dark parts being made up of a texture formed as an integral part of the sidewall (3) and contrasting against the rest of the tire (1). The texture is an organized arrangement of a plurality of elements (401, 402, 403, 404, 405, 411, 414).

### FIELD OF THE INVENTION

The present invention relates to a tire made of rubbery material comprising a sidewall.

### PRIOR ART

Document EP1636117 discloses how to use a coded matrix symbol on the sidewall of a tire, the said coded matrix symbol bearing information such as the individual serial number of the said tire, the website of the tire manufacturer, etc. A coded matrix symbol contains dark parts and light parts and in this instance is engraved directly into the sidewall of the tire.

Nowadays, there is a need to improve the legibility of the coded matrix symbols present on the sidewalls of tires in order to make them easier to read.

### DEFINITIONS

A “tire” means any type of resilient tread whether or not subjected to an internal pressure.

A “rubbery material” means a diene elastomer, namely in the known way an elastomer derived at least in part (i.e. a homopolymer or copolymer thereof) from diene monomers (conjugated or non-conjugated monomers bearing two carbon-carbon double bonds).

A “coded matrix symbol” means what is referred to as a “smart” code, in which the data is encoded in two dimensions (in the form of a plurality of rows and columns), the data being decodable by an imager of a machine, such as a mobile telephone. A coded matrix symbol encodes a markedly greater volume of data for the same given surface area than a traditional linear barcode and contains an in-built error correction system.

The “tread” of a tire means a quantity of rubbery material delimited by lateral surfaces and by two main surfaces, one of which, referred to as the tread surface, is intended to come into contact with a roadway when the tire is running.

The “sidewall” of a tire means the lateral surface of the tire positioned between the tread of the tire and a bead of this tire.

A “texture” means an organized arrangement of a plurality of elements, all or some of the elements of the arrangement being the repeat of one and the same basic element, for example a strand or a lamella.

A “strand” means a filiform element of which the height is at least equal to twice the diameter of a disc having the same surface area as a mean cross section of this strand.

“Lamellae” mean elongate strands that have a length at least equal to twice their height.

A “texture formed as an integral part of a sidewall” means that the texture is made from the same rubbery material as the sidewall of the tire. A texture is thus obtained without the addition of another material.

### SUMMARY OF THE INVENTION

The invention relates to a tire made of rubbery material comprising a sidewall. The sidewall comprises a coded matrix symbol, the said coded matrix symbol comprising dark parts and light parts, the dark parts being made up of a texture formed as an integral part of the said sidewall and contrasting against the rest of the tire. The texture is an organized arrangement of a plurality of elements.

The invention makes it possible to obtain dark parts of the coded matrix symbol in strong contrast with the light parts of this symbol. The coded matrix symbol is thus easier to read. Furthermore, such a texture formed as an integral part may be produced at the same time as the curing of the tire in the mould, thereby making the manufacturer of the matrix symbol more economical.

According to some nonlimiting embodiments, the tire may furthermore comprise one or more of the additional features selected from among the following.

In one nonlimiting embodiment, the coded matrix symbol is a symbol selected from a collection of symbols comprising:
a data matrix™
a QR™;
a QR code™;
a MaxiCode™;
a PDF-417™;
a code 16K™;
a code 49™,
an Aztec code™.

In one nonlimiting embodiment, the texture comprises a plurality of protruding elements or a plurality of first recessed elements set back from the surface of the sidewall.

The texture allows all or some of the incident rays of light that encounter the coded matrix symbol to become “trapped”. This allows the dark parts of the coded matrix symbol to be given a blacker appearance and that accordingly makes it possible to improve the contrast and therefore visibility thereof against the light parts and the remainder of the sidewall. Furthermore, this particular texture makes it possible to obtain a pleasant feel of the “velour” type in the region of the coded matrix symbol.

In one nonlimiting embodiment, all or some of the protruding elements are strands distributed through the texture with a density at least equal to one strand per square millimetre (mm²), each strand having a mean cross section of between 0.0005 mm² and 1 mm².

In one nonlimiting embodiment, all or some of the protruding elements are substantially mutually parallel lamellae, the spacing of the lamellae in the texture being at most equal to 0.5 mm, each lamella having a mean width of between 0.02 mm and 0.25 mm.

In one nonlimiting embodiment, all or some of the protruding elements form parallelepipeds of side length of between 0.05 mm and 0.5 mm, of height of between 0.05 mm and 0.5 mm, the distance between two adjacent parallelepipeds in the texture being between 0.05 mm and 0.5 mm.

In one nonlimiting embodiment, the first recessed elements form openings on the surface of the sidewall and the texture comprises a plurality of openings, these openings being distributed through the texture at a density at least equal to one opening per square millimetre (mm²), these openings having equivalent diameters of between 0.01 mm and 1.2 mm.

The texture is thus more durable. Indeed because the texture is made up of recessed elements set back from the surface of the sidewall, the impact of a roadway rubbing against this texture is lower.

In one nonlimiting embodiment, the light parts of the coded matrix symbol are made up of a pattern comprising a plurality of second recessed elements and/or of boss elements, each recessed element/boss element having the shape of part of a sphere.

The rays of light coming from one and the same light source and illuminating the sidewall of the tire are thus deflected in substantially the same way on the pattern.

In one nonlimiting embodiment, the second recessed elements are connected to one another at connection zones which extend above the mean surface of the sidewall.

That makes it possible to form elements that protect the light parts against phenomena of friction, originating, for example, from kerbing.

In one nonlimiting embodiment, when viewed in cross section, all or some of the second recessed elements/boss elements have an angular extent less than or equal to 70°.

That makes it possible to obtain a better reflecting surface for the light. The light parts therefore show up lighter on the sidewall of the tire.

In one nonlimiting embodiment, in the pattern, a second recessed element is positioned to alternate with a boss element, the light parts of the coded matrix symbol exhibiting, in this alternation, a variation in curvature of the cosine or sine type.

The rays of light originating from one and the same light source illuminating the sidewall of the tire are thus substantially deflected in the same way on the pattern.

In one nonlimiting embodiment, the light parts of the coded matrix symbol comprise a surface roughness of parameter Ra less than 30 μm.

That makes it possible to obtain a surface close to a polished surface and thus limit the scattering of the light.

In one nonlimiting embodiment, the coded matrix symbol is surrounded by a textured zone at least 2 mm in width formed integrally with the sidewall and contrasting with the rest of the tire.

That makes it possible to increase the contrast between the dark parts and the light parts of the coded matrix symbol. The symbol becomes accordingly easier to read.

In one nonlimiting embodiment, the coded matrix symbol follows a curvature of the sidewall of the tire.

That improves the appearance of the coded matrix symbol on the sidewall of the tire.

In one nonlimiting embodiment, the coded matrix symbol is set back into the sidewall of the tire.

That improves the protection afforded the coded matrix symbol against wear brought about, for example, by kerbing (scuffing against pavements).

### BRIEF DESCRIPTION OF THE DRAWINGS

Further features and advantages of the invention will become apparent from the following description, given by way of nonlimiting example, with reference to the attached drawings in which:

FIG. 1 is a schematic perspective view of part of a tire comprising a sidewall in which is arranged a coded matrix symbol according to the invention according to a first nonlimiting embodiment;

FIG. 2 is a schematic perspective view of part of a tire comprising a sidewall in which is arranged a coded matrix symbol according to the invention according to a second nonlimiting embodiment;

FIG. 3 is a schematic cross section of the sidewall of the tire of FIG. 2, in which the coded matrix symbol is set into the said sidewall;

FIG. 4 depicts a coded matrix symbol of the sidewall of FIG. 1 according to one nonlimiting embodiment, the coded matrix symbol comprising dark parts and light parts, the dark parts being made up of a particular texture;

FIG. 5 depicts the space occupied by the coded matrix symbol of FIG. 3 on the sidewall of the tire;

FIG. 6 depicts the coded matrix symbol of the sidewall of FIG. 2 surrounded by a textured zone;

FIG. 7 depicts part of the texture that makes up the dark parts of the coded matrix symbol of FIG. 4 or 6, according to a first nonlimiting embodiment;

FIG. 8 depicts part of the texture that makes up the dark parts of the coded matrix symbol of FIG. 4 or 6, according to a second nonlimiting embodiment;

FIG. 9 schematically depicts a perspective view of part of the tire of FIG. 1 comprising a sidewall on which is arranged a coded matrix symbol, zooming in on protruding elements that make up the dark parts of the coded matrix symbol;

FIG. 10 is a view in cross section of the texture of FIG. 7 or of FIG. 8, the texture being arranged with respect to the surface of the sidewall according to a first nonlimiting alternative form of embodiment;

FIG. 11 is a view in cross section of the texture of FIG. 7 or of FIG. 8, the texture being arranged with respect to the surface of the sidewall according to a second nonlimiting alternative form of embodiment;

FIG. 12 is a view in cross section of the texture of FIG. 7 or of FIG. 8, the texture being arranged with respect to the surface of the sidewall according to a third nonlimiting alternative form of embodiment;

FIG. 13 depicts the state of the texture of FIG. 12 present in the coded matrix symbol when the sidewall of the tire experiences mechanical load;

FIG. 14 depicts part of the texture that makes up the dark parts of the coded matrix symbol of FIG. 4 or 6 according to a third nonlimiting embodiment;

FIG. 15 depicts part of the texture that makes up the dark parts of the coded matrix symbol of FIG. 4 or 6 according to a fourth nonlimiting embodiment;

FIG. 16 depicts part of the texture that makes up the dark parts of the coded matrix symbol of FIG. 4 or 6, according to a fifth nonlimiting embodiment;

FIG. 17 depicts an enlarged view of a cavity of a recessed element of the texture of FIG. 16;

FIG. 18 is a perspective depiction of a plurality of recessed elements of a pattern making up the light parts of the coded matrix symbol of FIG. 4 or 6 according to a first nonlimiting embodiment;

FIG. 19 schematically depicts a view in cross section of part of the pattern of FIG. 18 according to a first nonlimiting alternative form of embodiment;

FIG. 20 schematically depicts a view in cross section of part of the pattern of FIG. 18 according to a second nonlimiting alternative form of embodiment;

FIG. 21 schematically depicts a view in cross section of recessed elements of a pattern making up the light parts of the coded matrix symbol of FIG. 4 or 6 according to a second nonlimiting embodiment;

FIG. 22 is a perspective depiction of a plurality of boss elements of a pattern that makes up the light parts of the coded matrix symbol of FIG. 4 or 6 according to a first nonlimiting embodiment;

FIG. 23 schematically depicts a view in cross section of part of the pattern of FIG. 22;

FIG. 24 schematically depicts a view in cross section of boss elements and boss elements of a pattern that makes up the light parts of the coded matrix symbol of FIG. 4 or 6 according to a second nonlimiting embodiment;

FIG. 25 is a perspective depiction of a plurality of recessed elements and boss elements of a pattern making up the light parts of the coded matrix symbol of FIG. 4 or 6 according to a nonlimiting embodiment; and

FIG. 26 schematically depicts a view in cross section of part of the pattern of FIG. 25.

In the description which will follow, elements that are substantially identical or similar will be denoted by identical references.

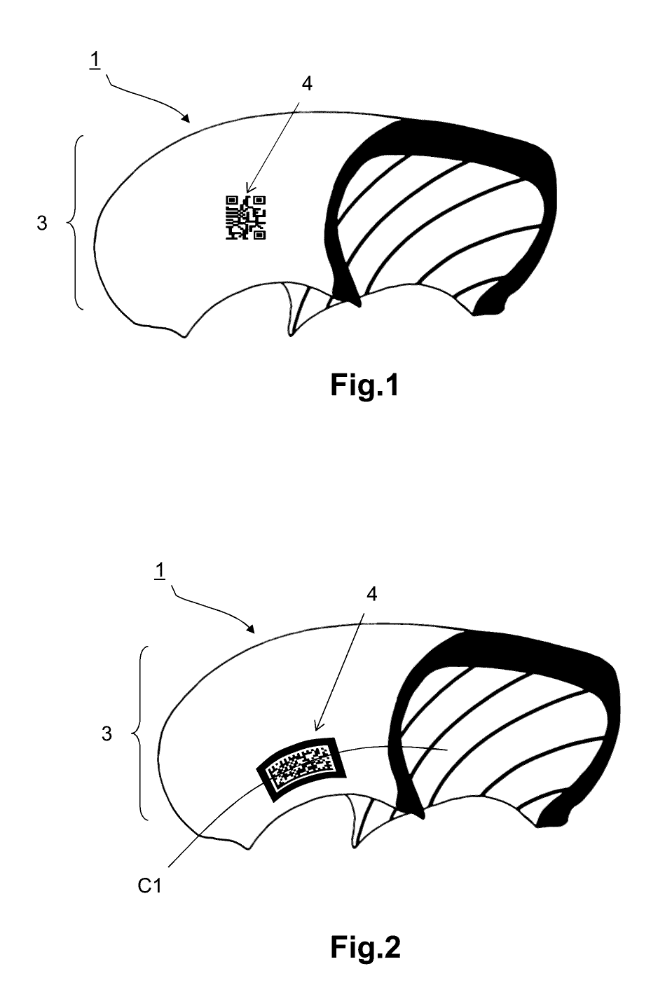

FIG. 1 illustrates the sidewall 3 of a tire 1, the said sidewall 3 comprising a coded matrix symbol 4.

In one nonlimiting embodiment, the coded matrix symbol 4 is selected from among the following symbols:
a data matrix™
a QR™;
a QR code™;
a MaxiCode™;
a PDF-417™;
a code 16K™;
a code 49™,
an Aztec code™, or any other coded matrix symbol.
   Of course, other coded matrix symbols may be used.

The coded matrix symbol 4 makes it possible to encode information such as the manufacturer's mark, the manufacturer's website, etc. Using reading/decoding means such as an imager built, by way of nonlimiting example, into a mobile telephone, somebody looking at the tire will be able to read and decode the coded matrix symbol 4 and access the manufacturer's website, for example in order to order a new tire.

As illustrated in FIG. 2, in one nonlimiting embodiment, the coded matrix symbol 4 follows the curvature C1 of the sidewall 3 of the tire 1, the said curvature being defined along a parallel with respect to the axis of rotation of the tire. In other words, the coded matrix symbol 4 is curved about the axis of rotation of the tire 1. That gives the tire a more attractive appearance because the coded matrix symbol 4 appears as forming an integral part of the sidewall 3.

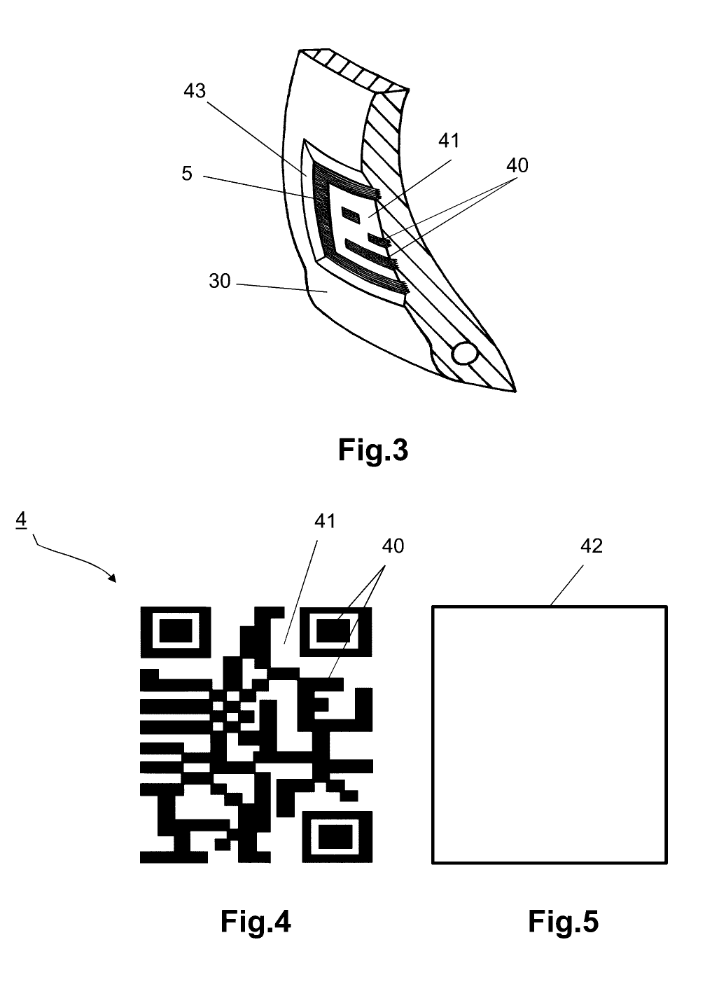

In one nonlimiting embodiment as illustrated in the view in cross section of FIG. 3, the coded matrix symbol 4 is recessed into the sidewall 3 of the tire. The sidewall 3 comprises a housing 43 into which the coded matrix symbol 4 is inset. The dark parts 40 (whether made up of protruding elements 401, 402, 403, 404 or recessed elements 405 described later on in the description) and the light parts 41 (whether they are made up of boss elements 414 or recessed elements 411 described later on in the description) extend below the surface 30 of the sidewall 3, the said surface being the upper surface of the sidewall. Thus, the fact that these elements do not come up as high as the surface 30 of the sidewall 3 means that it is possible to have a coded matrix symbol 4 that is more robust notably against kerbing. Furthermore, it causes less of a disruption to the air flow which is therefore more fluid and therefore better follows the said surface 30 of the sidewall 3.

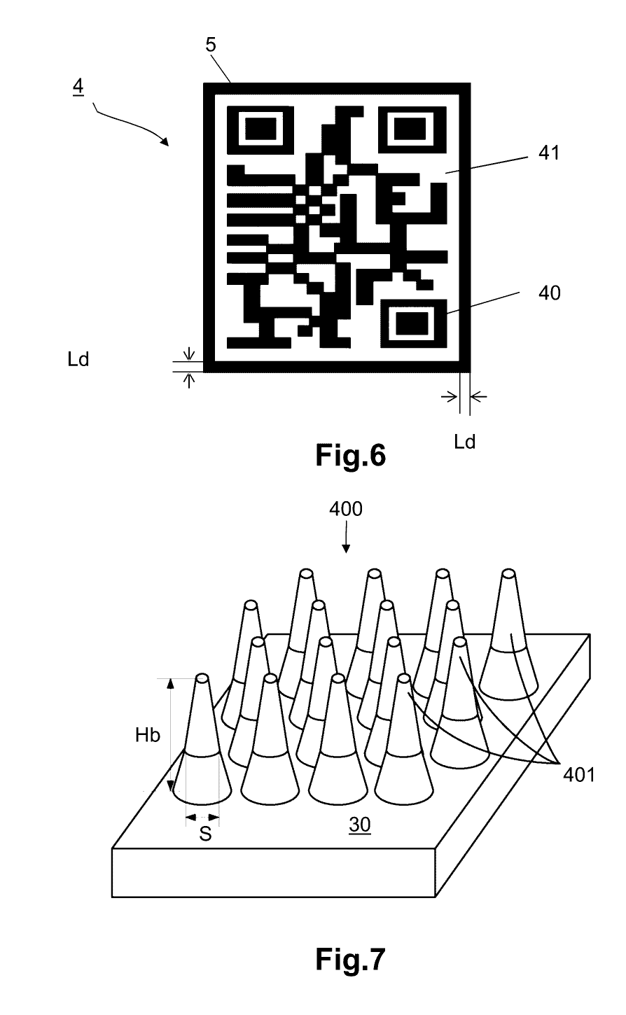

FIG. 4 depicts a first nonlimiting embodiment of a coded matrix symbol 4. As can be seen in the figure, the coded matrix symbol 4 comprises dark parts 40 and light parts 41. In a way known to those skilled in the art, in one nonlimiting embodiment, the dark parts 40 and light parts 41 are, respectively, dark boxes and light boxes, a part corresponding to a box. The coded matrix symbol 4 thus comprises columns and rows of boxes (or squares). In one nonlimiting embodiment, a box has a size of between 0.5×0.5 mm to 2×2 mm. Outside of that range, the coded matrix symbol 4 becomes too intrusive or too miniaturized and therefore too fragile to be decoded at the end of life of the tire 1. In a nonlimiting alternative form of embodiment, a box has a size of 1×1 mm. In another nonlimiting embodiment, the dark parts 40 and light parts 41 are dark circles and respectively light circles. In another nonlimiting embodiment, it is possible to have a combination of boxes and circles. The coded matrix symbol 4 occupies a space 42 on the sidewall 3 of the tire 1 as illustrated in FIG. 5.

FIG. 6 depicts a second nonlimiting embodiment of the coded matrix symbol 4. As can be seen in the figure, apart from the dark parts 40 and the light parts 41, the coded matrix symbol 4 is surrounded by a textured zone 5 at least 2 mm in width Ld formed as an integral part of the sidewall and contrasting against the rest of the tire 1. This delineation zone 5 does not touch the dark zones 40 of the coded matrix symbol 4. It is made up of the same “velour” type texture (described later on in the description) as the dark parts 40, so that the quantity of black surface in the image capture zone around the coded matrix symbol 4 is increased.

Thus, by increasing the quantity of black surface in this way, the contrast between the light and dark regions of the matrix symbol 4 in the processing performed by the mobile telephone is increased. This accordingly improves the reading/decoding of the symbol 4.

The dark parts 40 and the light parts 41 of the coded matrix symbol 4 are set out in the remainder of the description according to some nonlimiting embodiments.

The dark parts 40 of the coded matrix symbol 4 are described hereinafter.

The dark parts 40 are made up of a texture 400 formed as an integral part of the said sidewall 3. The texture 400 contrasts with the rest of the tire 1 and notably the rest of the sidewall 3 of the tire 1 so that the coded matrix symbol 4 is clearly visible on the sidewall 3 to somebody looking at the tire.

The texture 400 that forms the dark parts 40 comprises a plurality of protruding elements 401, 402, 403, 404 protruding with respect to the surface 30 of the sidewall 3 or a plurality of first recessed elements 405 set back from the surface 30 of the sidewall 3. These elements 401 to 405 are therefore likewise made of a rubbery material. In other words, a dark box 40 comprises a plurality of elements 401, 402, 403, 404 or 405.

Various ways of embodying the protruding elements 401, 402, 403, 404 of the texture 400 are set out hereinafter.

The effect that the protruding elements 401, 402, 403, 404 have is that of “trapping” a large quantity of the incident rays of light impinging on the texture 400. The texture 400 (referred to as “velour”) makes it possible to obtain a visual of the “velour” type because the protruding elements absorb the light and thus make the dark parts 41 of the coded matrix symbol 4 blacker. Somebody looking at the tire will clearly be able to distinguish these dark parts 40 from the light parts 41 and from the rest of the sidewall 3. Moreover, the texture 400 is of the “velour” type because it is pleasant to the touch.

In a first embodiment illustrated in FIG. 7, all or some of the protruding elements are strands 401. In this figure, the strands 401 have a conical overall shape with a cross section reducing along the height Hb of these strands. More specifically, the mean cross section of each strand, which corresponds to the mean of the cross sections S measured at regular intervals from the base of the strand onwards, is comprised between 0.0005 mm² and 1 mm². In the texture 400, the strands are distributed with a density at least equal to one strand per square millimetre.

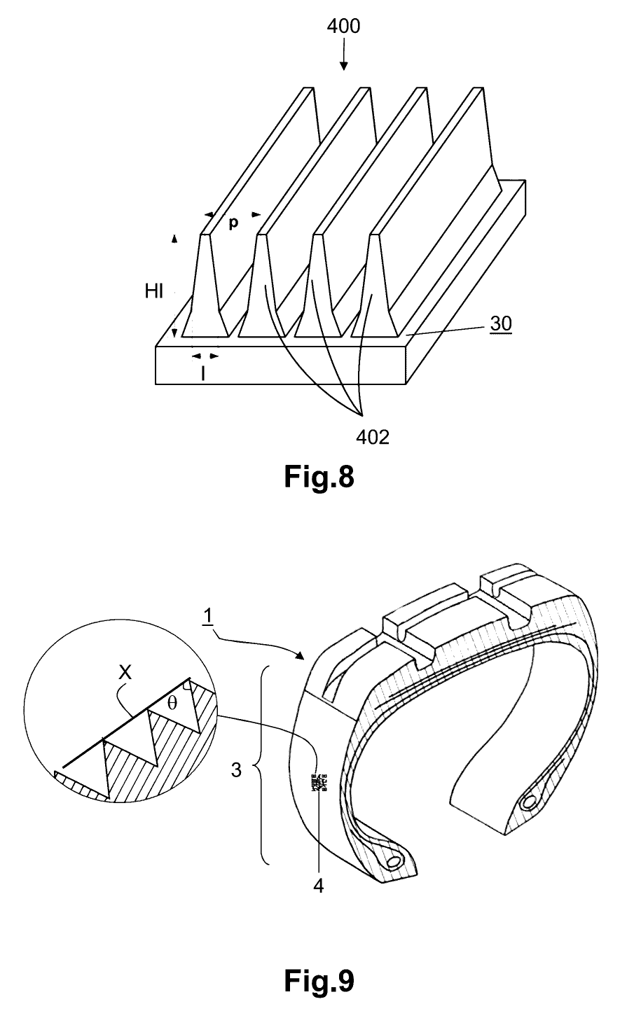

In a second embodiment illustrated in FIG. 8, all or some of the protruding elements are lamellae 402. In this figure, the lamellae 402 have a triangular overall cross section and the mean width of each lamella, corresponding to the mean of the width L measured at regular intervals along the height H1 of the lamella, is comprised between 0.02 mm and 0.25 mm. In the texture 400, the lamellae 401 are substantially mutually parallel and the spacing P of the lamellae is at least equal to 0.05 mm and at most equal to 0.5 mm.

In another embodiment, the texture 400 comprises a combination of strands 401 and of lamellae 402.

In one nonlimiting embodiment, at least 30% of the protruding elements of the texture 400 make an angle θ greater than 40° with respect to a plane X tangential to the surface 30 of the sidewall 3 and at most 25% of the protruding elements of the texture 400 make an angle θ less than 20° with respect to the tangential plane X. The zoomed-in part of the texture 400 depicted in FIG. 9 schematically illustrates the protruding elements, the said tangential plane X and the said angle θ. It will be noted that the angle θ is the angle between the tangential plane X and the side of the protruding elements. The ability of the texture 400 to trap light is improved further in this way. This embodiment applies to the protruding elements 401 and 402 described above.

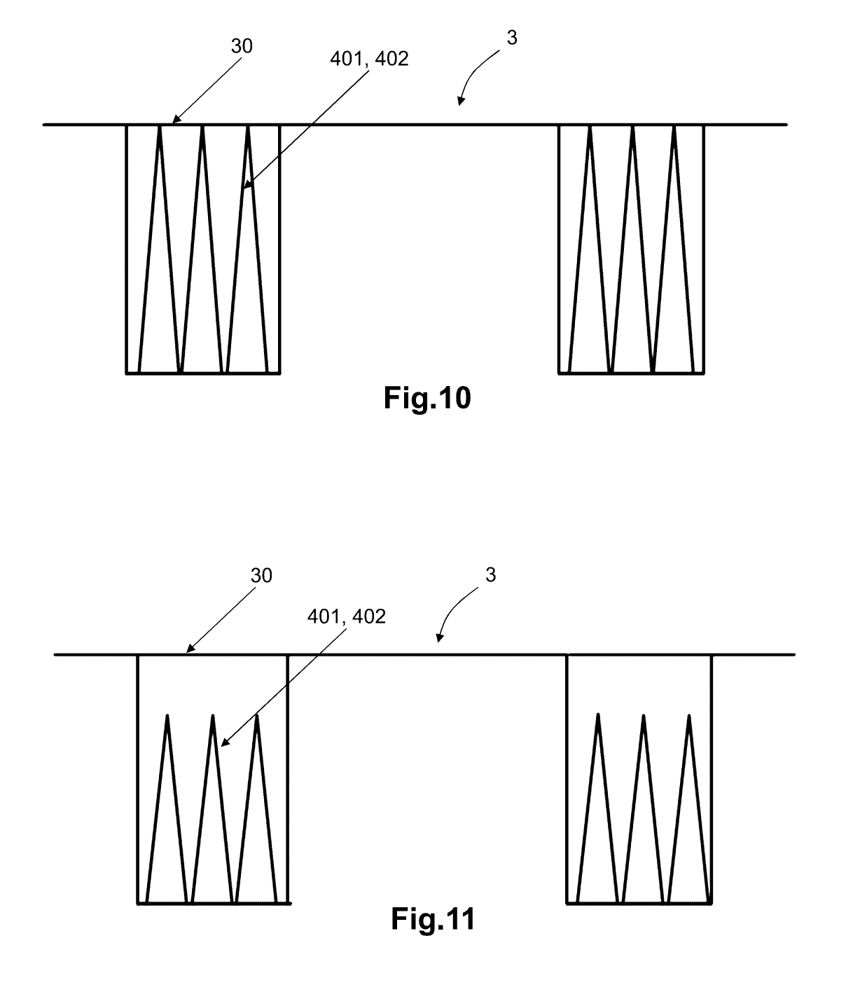

FIGS. 10 to 13 depict views in cross section of the texture 400 of the dark parts 40 which is arranged with respect to the surface 30 of the sidewall 3 according to nonlimiting alternative forms of embodiment of the first and second embodiments of the texture 400 set out hereinabove. The texture 400 comprises strands 401 and/or lamellae 402.

In a first nonlimiting alternative form of embodiment visible in FIG. 10, the strands 401 of the texture 400 or, respectively, the lamellae 402 of the texture 400 in this instance lie flush with the surface 30 of the sidewall 3 of the tire 1, which means to say that the vertices of these strands 401 or, respectively, the vertices of these lamellae 402 are at the same level as the surface 30 of the sidewall 3.

In a second nonlimiting alternative form of embodiment visible in FIG. 11, the strands 401 of the texture 400 or, respectively, the lamellae 402 of the texture 400 are set back from the surface 30 of the sidewall 3 of the tire 1, which means to say that the vertices of these strands 401 or, respectively, the vertices of these lamellae 402 are below the surface 30 of the sidewall 3.

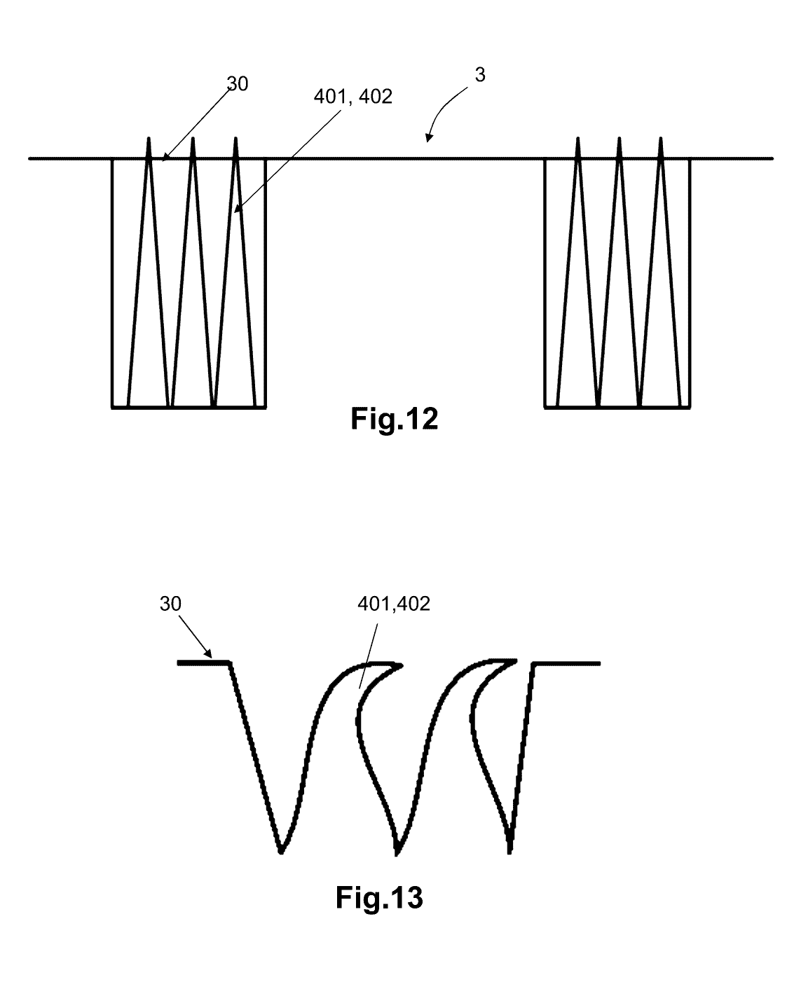

In a third alternative form of embodiment visible in FIG. 12, the strands 401 of the texture 400 or, respectively, the lamellae 402 of the texture 400 extend beyond the surface 30 of the sidewall 3 of the tire 1, which means to say that the vertices of these strands 401 or, respectively, the vertices of these lamellae 402 protrude beyond the surface 30 of the sidewall 3. If the sidewall 3 of the tire is scuffed at the location of the coded matrix symbol 4, the strands 401 or, respectively, the lamellae 402 flex, as can be seen in FIG. 13, absorbing all or some of the friction of this rubbing.

In another nonlimiting (not illustrated) alternative form of embodiment, the texture 400 comprises a combination of the second and third alternative forms of embodiment, namely some of the strands 401 of the texture or, respectively, some of the lamellae 402 of the texture protrude beyond the surface 30 of the sidewall 3 of the tire 1 and another proportion of these strands 401 or, respectively, these lamellae 402 are set back from the said surface. In one nonlimiting embodiment, at least 50% of the strands 401 or, respectively, of the lamellae 402 protrude beyond the surface 30 of the sidewall 3.

Thus, having the dark parts 40 of the coded matrix symbol 4 made up of strands and/or lamellae fully or partially inset affords protection against kerbing. Indeed, the friction forces that lead to abrasion are absorbed by the surface 30 of the sidewall 3, and the pressure applied to the coded matrix symbol as a result of the friction forces is low because of the flexibility of the said strands and/or lamellae.

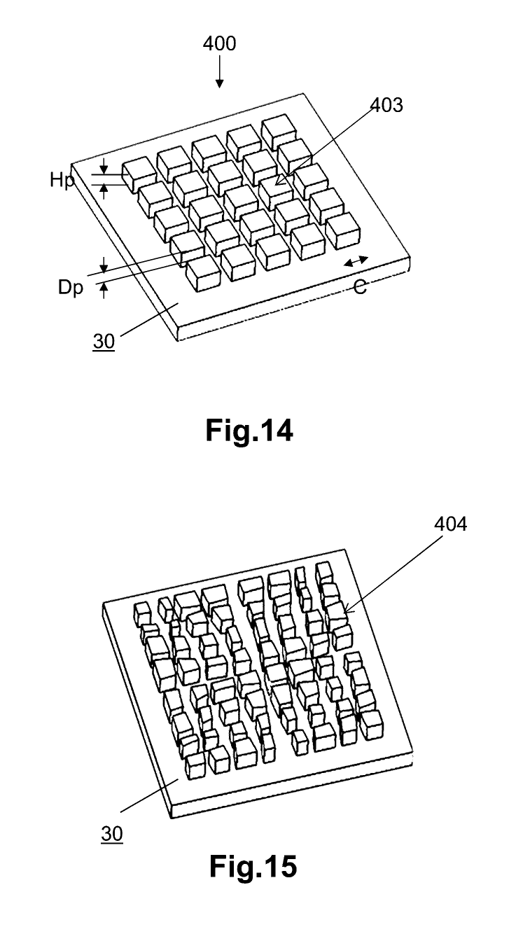

In a third nonlimiting embodiment illustrated in FIG. 14, all or some of the projecting elements form parallelepipeds 403 of side length C comprised between 0.05 mm and 0.5 mm, of height Hp comprised between 0.05 mm and 0.5 mm, the distance Dp between two adjacent parallelepipeds 403 in the texture being comprised between 0.05 mm and 0.5 mm.

In another embodiment, the texture 400 comprises a combination of protruding elements 401, 402 and 403, or 401 and 403 or even 402 and 403 as described hereinabove.

In a fourth nonlimiting embodiment illustrated in FIG. 15, the protruding elements 404 have, in the texture, variable shapes and variable distances between protruding elements. That makes it possible to create randomness in the texture, which in turn makes it possible to make these elements less visible.

In one nonlimiting example, the projecting elements 401 to 404 of the texture 400 are moulded by part of a mould, the said mould part having previously undergone a pulsed laser etching operation for the purpose of the moulding of the said elements 401 to 404.

The first recessed elements 405 (also referred to as holes) of the texture 400 are set out hereinafter.

The first recessed elements 405 are made up of openings 406 on the surface 30 of the sidewall 3 and of associated cavities 407 extending into the depth of the surface 30 of the sidewall 3.

Thus, the texture 400 comprises a plurality of openings 406 in the surface 30 of the sidewall 3, the said openings 406 being distributed through the texture 400 at a density at least equal to one opening per square millimetre (mm²) and having, on the surface 30 of the sidewall 3, equivalent diameters Dt of between 0.01 mm and 1.2 mm.

In one nonlimiting embodiment, the openings 406 occupy at least 30% of the texture. According to other nonlimiting embodiments, the openings 406 occupy at least 50% of the texture, or even over 70%. It will be noted that the greater the level of occupancy of the openings in the texture, the better the quality of contrast of this texture and therefore of the dark parts 40 of the coded matrix symbol 4 with respect to the light parts 41 and the rest of the sidewall 3.

The openings 406 extend into the depth of the surface 30 of the sidewall 3 to form cavities 407.

The effect that these cavities 407 have is that they “trap” a large quantity of the incident rays of light impinging on the texture, and also that they make the texture more durable. Specifically, because the cavities 407 are recessed into the surface 30 of the sidewall 3, the impact that mechanical attacks, such as friction of a roadway, have on the texture is smaller than it is for the protuberances. In this embodiment, the texture (referred to as “velour”) makes it possible to obtain a visual of the “velour” type because the cavities absorb the light and thus make the dark parts 40 of the coded matrix symbol 4 blacker.

In one nonlimiting embodiment, all or some of the cavities 407 has a depth at least equal to 0.1 mm. In one nonlimiting alternative form of embodiment, all or some of the cavities 407 has a depth comprised between 0.2 mm and 0.6 mm. In this way, it is possible to ensure that a large quantity of incident rays of light impinging on the texture becomes trapped by the said texture 400.

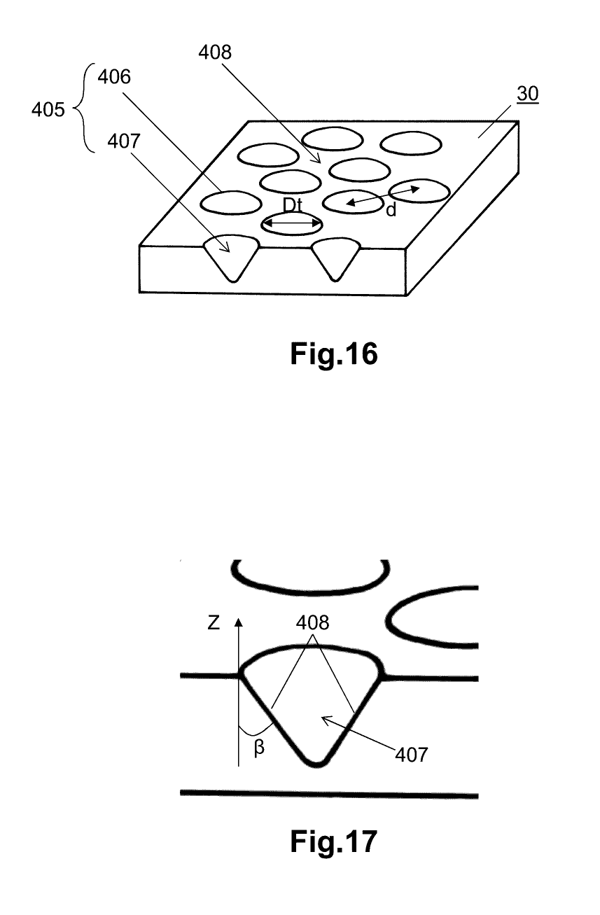

FIG. 16 illustrates the texture 400 according to a nonlimiting alternative form of embodiment. In this alternative form, all or some of the cavities 407 are shaped as cones which extend into the depth of the surface 30 of the sidewall 3 and open onto the said surface forming circular openings 406. The cavities 407 thus have a cross section that decreases into the depth of the surface 30 of the sidewall 3. In this way, the contrast between the texture 3 and therefore the coded matrix symbol 4 and the rest of the tire 1 and more particularly the rest of the sidewall 3 is improved. It will be noted that, in this alternative form, the openings 406 of the cavities 407 do not touch. The openings 406 are separated by intermediate zones 408. Furthermore, the openings 406 are evenly distributed through the texture so that the distance d between each opening of the texture is roughly the same.

FIG. 17 is a zoom in onto a cavity 407 of a recessed element 405 of the texture 400. In one nonlimiting embodiment, all or some of the cavities have at least one wall 409 which, when viewed in cross section, forms an angle β comprised between 10° and 60° with respect to a direction Z perpendicular to the texture.

Each time a ray of light encounters a wall 409 of the cavity 407, this light is reflected by the said wall 409. The direction in which the ray of light is reflected is dependent on the initial direction of this ray of light and on the angle of inclination of the wall 409. Thus, depending on this initial direction and on this angle of inclination, the ray of light may be reflected towards another wall 409 of the cavity. Conversely, the ray of light may be reflected out of the cavity, for example directly towards an observer. In the former instance, the ray of light “becomes lost” in the cavity and will no longer be perceptible to the eye of an observer. In the latter instance, the observer can see the ray of light and the texture may then appear as being lighter and therefore less in contrast with the rest of the sidewall. By choosing a cavity 407 that has at least one wall 409 that forms an angle β comprised between 10° and 60° it is possible to ensure that a large proportion of the rays of light entering the cavity 407 will be absorbed by this cavity under the effect of multiple reflections within the cavity. This then improves the contrast of the texture (and therefore of the dark parts 40 of the coded matrix symbol 4) against the rest of the tire 1 (notably against the light parts 41 and the rest of the sidewall 3) while at the same time keeping the same level of occupancy of the cavities in the texture 400. Furthermore, with this wall inclination, the resistance of the texture 400, notably to repeated rubbing against the roadway, is improved overall.

In one nonlimiting example, the first recessed elements 405 of the texture 400 are manufactured directly on the tire by laser etching or moulded by part of a mould, the said mould part having previously undergone a laser etching of the mould in order to obtain the said elements 405.

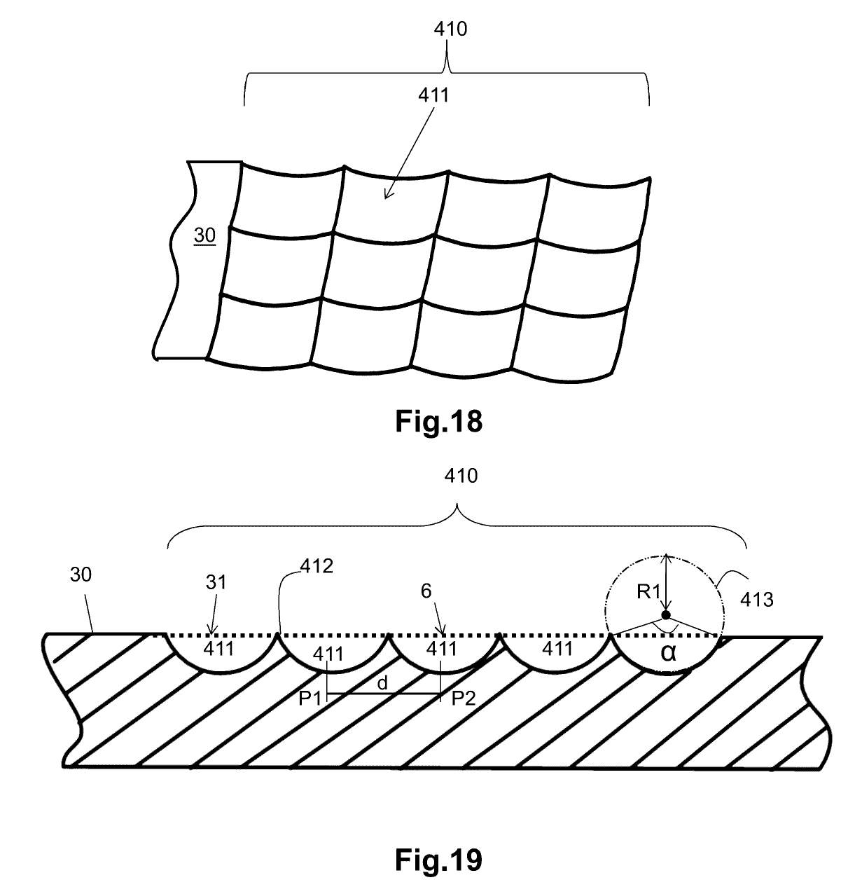

With reference to FIGS. 18 to 26, the light parts 41 of the coded matrix symbol 4 are described hereinafter.

In a first nonlimiting embodiment, the light parts 41 are made up of part of the surface 30 of the sidewall 3 that has not been covered with the “velour” type texture 400 described hereinabove, which part of the surface 30 of the sidewall is delimited by the space 42 occupied by the coded matrix symbol 4. Specifically, the surface 30 of the sidewall 3 is smooth and reflects light. A person looking at the tire will perceive a grey-white colour. Thus, the light parts 41 will stand out in contrast against the dark parts 40 described hereinabove.

In a second nonlimiting embodiment, the light parts 41 are made up of a pattern 410 comprising:
a plurality of second recessed elements 411; or
a plurality of second boss elements 414; or
a combination of second recessed elements 411 and of second boss elements 414.
   In other words, a light box 41 comprises a plurality of elements 411 and/or 414.
   That allows the parts 41 to be made even lighter than the smooth surface of the sidewall 3.
   The pattern 410 is also formed as an integral part of the said sidewall 3. It is made of the same rubbery material as the sidewall of the tire. The elements 411 and 414 are therefore made of rubbery material.

The various elements 411 and 414 and combinations thereof are described herein below.

With reference to FIGS. 18 to 21, the second recessed elements 411 are set out hereinafter.

FIG. 18 shows an enlarged perspective view of part of the pattern 410 comprising second recessed elements 411 according to a first nonlimiting embodiment. The second recessed elements 411 all have the same shape. The shape is an open surface. In the nonlimiting embodiment illustrated in FIG. 18, the second recessed elements 411 are aligned one with respect to the other. This allows the light parts 41 to be clearly delineated.

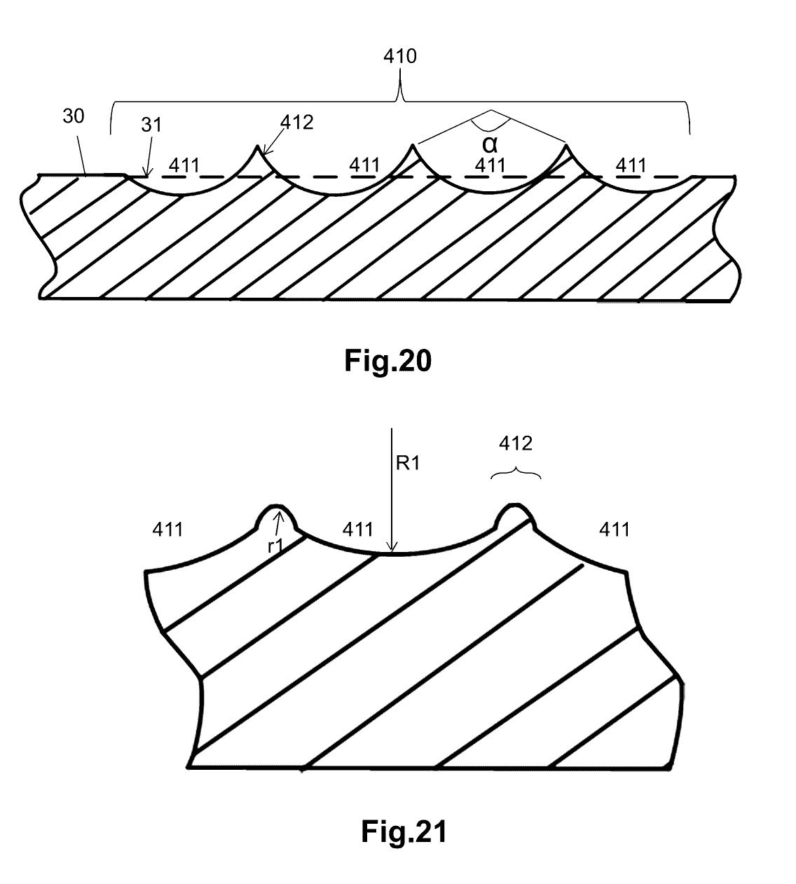

FIG. 19 and FIG. 20 are a view in cross section of part of the second recessed elements 411 of FIG. 18. A second recessed element 411 has the shape of part of a sphere. It rests against a sphere 413 that has a first radius R1. When viewed in cross section, the geometric shape of the second recessed elements 411 is concave. Each second recessed element 411 is adjacent to another second recessed element 411. In addition, the second recessed elements 411 connect to one another at connection zones 412.

The distance d (also referred to as the “spacing”) between the equidistant point P1 of one recessed element 411 and the equidistant point P2 of another, adjacent, recessed element is less than the diameter of the sphere 413 on which the recessed element rests. In one nonlimiting embodiment, the spacing d between two adjacent equidistant points P1-P2 of two adjacent recessed elements 411 is greater than or equal to 0.3 mm and less than 2 mm. Thus, the human eye, from a distance of more than 2 metres, will merely perceive a texture of the pattern 410 that is uniform in colour. In one nonlimiting example of embodiment, the spacing d between two adjacent vertexes P1-P2 is equal to 1 mm. That makes creating the recessed elements 411 on an industrial scale easier and allows for inexpensive tooling.

FIG. 19 shows a first nonlimiting alternative form of embodiment of an arrangement of the elements 411 with respect to the surface of the sidewall 3, in which arrangement the connection zones 412 of the second recessed elements 411 are situated at the same level as the mean surface 31 of the sidewall 3 along which the sidewall extends.

FIG. 20 shows a second nonlimiting alternative form of embodiment of an arrangement of the elements 411 with respect to the surface of the sidewall 3, in which arrangements the connection zones 412 of the second recessed elements 411 extend above the sidewall. More particularly, the connection zones 412 extend above the mean surface 31 along which the sidewall extends.

FIG. 21 is an enlarged view in cross section of a plurality of second recessed elements 411 of the pattern 410 according to a second embodiment in which the second recessed elements 411 are connected to one another at connection zones 412, these connection zones 412 being curved and having a blend radius r1 such that r1≦R1/3.

Boss elements 414 are presented hereinafter with reference to FIGS. 22 to 24.

FIG. 22 shows an enlarged perspective view of part of the pattern 410 comprising second boss elements 414 according to a first nonlimiting embodiment. The second boss elements 414 all have the same shape. The shape is a closed surface. The shape is a cap of a sphere of second radius R2, also referred to as a shell or microlens. A cap of a sphere means a cap of which the second radius R2 is constant. As an alternative, the second radius R2 of the caps may be variable to plus or minus 10%. In the nonlimiting embodiment illustrated in FIG. 22, the boss elements 414 are aligned relative to one another. That allows the light parts 41 to be clearly delineated.

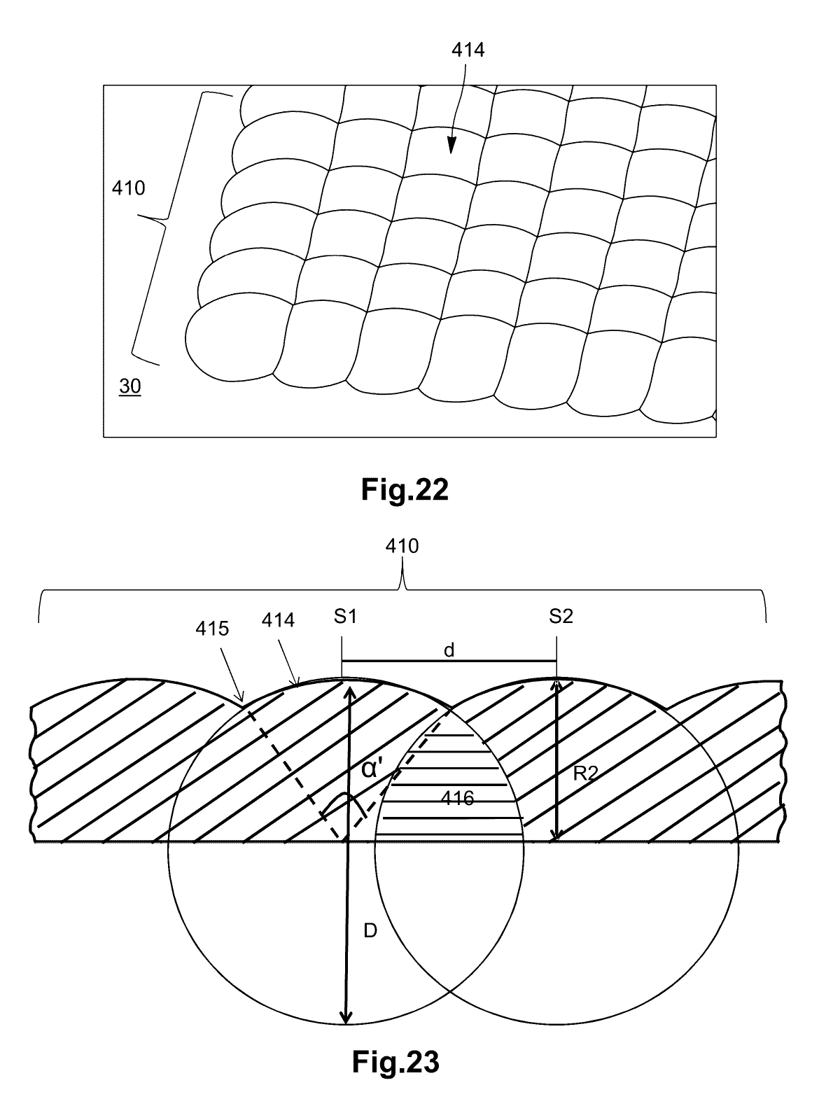

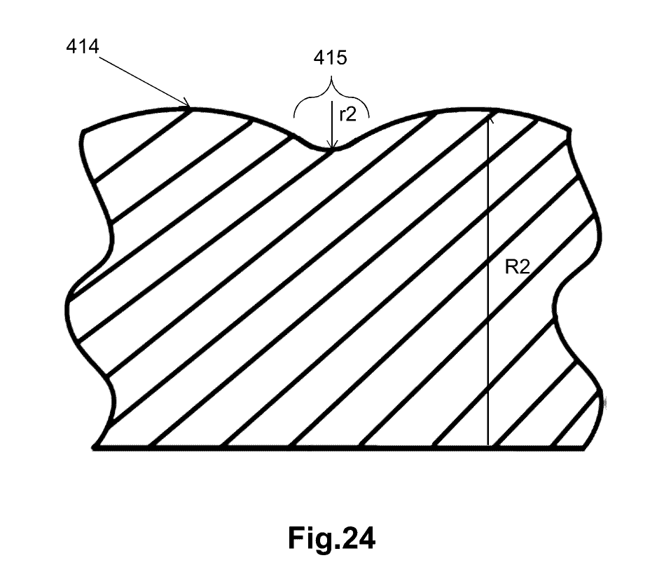

When viewed in cross section (FIG. 23), the geometric shape of the boss elements 414 is thus convexed. Each cap of a sphere 414 is interpenetrated with several adjacent boss elements. Thus, as illustrated in FIG. 23, the distance d (also referred to as the “spacing”) between the vertex Si of one cap of a sphere and the vertex S2 of another adjacent cap of a sphere is less than the diameter D of this cap of a sphere. In one nonlimiting embodiment, the spacing d between two vertexes S1-S2 is greater than or equal to 0.3 mm and less than 2 mm. Thus, the human eye, from a distance of more than 2 metres, will see only a texture of the pattern that is uniform in colour. In one nonlimiting embodiment, the spacing d between two vertexes S1-S2 is equal to 1 mm. That makes the caps easier to produce on an industrial scale and makes it possible to use inexpensive tooling.

As can be seen in FIG. 23, the caps of a sphere 414 interpenetrate one another and so therefore have a common zone 416 (illustrated by horizontal hatching). It may also be seen that by virtue of this design of interpenetrating caps of spheres, these caps have limited inter-cap spaces 415, which means to say that these spaces have a small surface area.

FIG. 24 shows a second nonlimiting embodiment of the boss elements 414, in which embodiment said elements 414 connect at the inter-cap spaces 415 also referred to as connection zones 415. These connection zones 415 are curved and have a blend radius r2 such that r2≦R2/3. This then limits the risk of cracks spreading through the pattern 410 in the connection zones.

In order to improve still further the reflection of light by the texture (which then makes it possible to reveal the parts 41 of the coded matrix symbol 4 as being even lighter), use is made of the following nonlimiting embodiments.

In one nonlimiting embodiment, the second recessed elements 411 have an angular extent α less than or equal to 70° and the boss elements 413 have an angular extent α′ less than or equal to 70°. In the latter instance, the inter-cap spaces 415 are optimally reduced. If the extent α, α′ were greater, that would carry with it a significant risk of light absorption.

The rays of light incident on the second recessed elements 411 and on the caps of spheres 414 are reflected towards the observer. The light is not absorbed much by the texture of the sidewall 3 of the tire. There are therefore no so-called “black” regions. The collection of recessed elements 411 and/or boss elements 414 makes it possible to create regions referred to as “white” regions because of the optimized reflection of the light off the said elements, that region corresponding to the light parts 41 of the coded matrix symbol 4.

In one nonlimiting embodiment, the second recessed elements 411 and the caps 414 have a texture similar to a smooth reflective surface, which evens out the mean intensity of light reflected. The arithmetic mean deviation parameter Ra indicative of the surface roughness is very low and less than 30 μm. The light parts 41 thus have a surface roughness of parameter Ra less than 30 μm. The amount of light reflected is thus maximized.

In order to obtain a method of manufacture that is easy to implement, in one nonlimiting embodiment, the density of recessed elements 411 and of boss elements 414 in the pattern 410 is greater than or equal to 0.2 elements per mm². In one nonlimiting example, the recessed elements 411/boss elements 414 are moulded by part of a mould, the said mould part having previously undergone a knurling operation for the moulding of the recessed elements 411/boss elements 414.

That also allows elements 411, 414 to be produced that are aligned in the light parts 41 in at least one preferred direction and do so in a simple and economical way. Furthermore, it allows the light parts 41 to be given a more uniform appearance in so far as an observer is concerned.

Thus, by virtue of these second recessed elements 411/boss elements 414, the coded matrix symbol 4 comprises parts 41 which look lighter to an observer of the tire 1 than the dark parts 40 and are therefore clearly distinguishable from these dark parts 40. That makes the coded matrix symbol 4 easier to read/to decode.

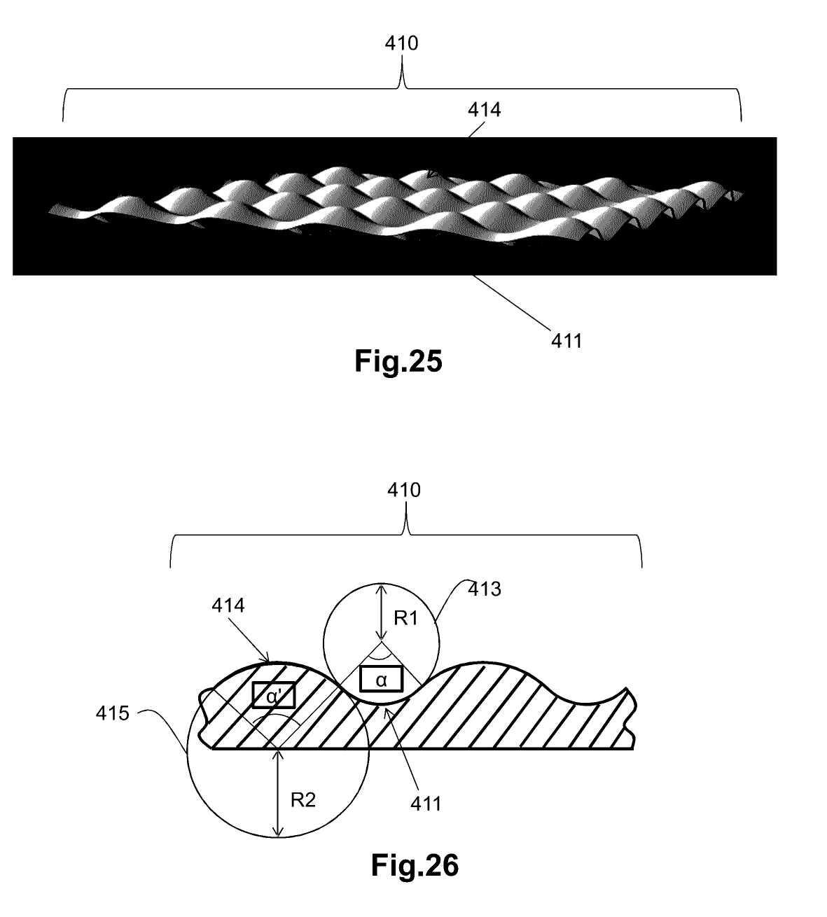

The combination of second recessed elements 411 and boss elements 414 is explained hereinafter with reference to FIGS. 25 and 26.

The pattern 410 may comprise a repeat of these two same forms 411 and 414 which alternate with one another, a recessed element 411 being positioned in alternation with a boss element 414. There is a recessed element 411 adjacent to two boss elements 414, and a boss element 414 adjacent to two recessed elements 411. Thus, the pattern 410 and therefore the light parts 41 of the coded matrix symbol 4 exhibit, in this alternation, a variation in curvature of the cosine or sine type as illustrated in FIG. 26.

Such a pattern 410 makes it possible to conceal potential deformations of the sidewall such as hollows in the sidewall. Such deformations are notably due to surplus carcass ply, said ply forming part of the tire. Each recessed element 411 and boss element 414 has the particular property of reflecting a quantity of light that remains constant even when the pattern is inclined by a small angle with respect to an original position corresponding, in this example, to the position on a non-deformed sidewall. In a nonlimiting example, the inclination of the angle is less than 5°, which corresponds to the inclination of the indentation created by sidewall deformation with respect to the non-deformed surface of the sidewall. The visual effect created by the recess is practically no longer visible, if visible at all, whatever the position occupied by an observer with respect to the sidewall of the tire. The entire pattern makes it possible to create a zone of uniform light reflection because of the optimized reflection of light off this pattern 410.

The second radius R2 is such that 1/3 R1<R2<3 R1. In a nonlimiting alternative form of embodiment, the second radius R2 is greater than the first radius R1. This configuration makes it possible, in the event of abrasion, to afford more effective protection to the recessed part of first radius R1.

In a nonlimiting embodiment illustrated in FIG. 25, in the pattern 410, the recessed elements 411 are aligned relative to one another and the boss elements 414 are aligned relative to one another. In other words, the vertices of the boss elements 414 are positioned in a grid pattern the axes of which intersect at 90°. That allows the light parts 41 to be clearly delineated.

In one nonlimiting embodiment, when viewed in cross section through the vertices of the boss elements 414, the angular extent α′ of the said elements 414 is equal to the angular extent α of the recessed elements 411 as illustrated in FIG. 26. That makes it possible to have continuity in a light part 41 without any angular points between a recessed element 411 and a boss element 414.

The collection of elements 411-414 makes it possible to create a light reflection zone that is uniform because of the optimized reflection of the light.

The invention is not restricted to the examples described and depicted and various modifications can be made thereto without departing from its scope.

Thus, according to another nonlimiting alternative form of embodiment, the lamellae 402 of FIG. 8 may be discontinuous. They have a planar part between them. They may furthermore have differences in cross section relative to one another. In addition, the lamellae may have curvatures or angles, notably along their length. They may furthermore be of variable length.

Thus, according to another nonlimiting alternative form of embodiment, the openings 406 of FIG. 16 may have a circular, square or even polygonal (for example hexagonal) shape and the corresponding cavities 407 a cylindrical, parallelepidedal or even polygonal shape. With the last two structures (square or polygonal) it is possible to organize the openings 406 relative to one another more easily so as to limit the surface area of the intermediate zones 408 between these openings. With such shapes of opening it is possible more easily to achieve significant levels of occupancy of the openings.

Thus, according to another nonlimiting alternative form of embodiment, the pattern 410 comprises second recessed elements 411 or boss elements 414 that are not aligned.

Thus, the invention has been described in relation to a coded matrix symbol. However, in another exemplary embodiment, the sidewall 3 may comprise several coded matrix symbols.

Thus, according to another nonlimiting alternative form of embodiment, the coded matrix symbol may be created in two steps: one step prior to curing and one step after curing. The light parts 41 are moulded with the tire 1, and therefore prior to curing, whereas the dark parts 40 are produced on the cured tire and therefore after curing. The dark parts 40 are obtained by laser etching onto the cured tire.

The invention described notably offers the following advantages:
the texture of the dark parts 41 of the coded matrix symbol 4 (whether this be with protruding elements or with first recessed elements) means that light can be absorbed and the dark parts therefore given a blacker appearance. This then improves the contrast between the dark parts 40 and:
the rest of the sidewall 3 of the tire, thereby making it possible easily to discern the coded matrix symbol 4 on the sidewall 3;
the light parts 41, thereby making it possible easily to distinguish the dark parts from the light parts and therefore make the reading/decoding of the coded matrix symbol easier. Errors in the reading/decoding by an imager are thus reduced.
by virtue of the composition of the coded matrix symbol 4 which has a “velour” type texture for the dark parts 40 and second recessed/boss elements for the light parts 41, manufacture of the coded matrix symbol 4 can be incorporated into the manufacture of the tire 1 using an integrated mould, rather than after the manufacture of the tire. Production is therefore simplified and costs reduced.
the “velour” type texture of the dark parts 41 makes it possible:
   for the coded matrix symbol 4 to have a texture that is pleasant to touch;
   to obtain a coded matrix symbol 4 that is robust and does not deform. The coded matrix symbol 4 wears away far less than an etched matrix symbol. The decoding of the symbol 4 will always be effective even when the tire becomes worn;
the texture zone 5 surrounding the coded matrix symbol 4 makes it possible clearly to target the location of the symbol 4 and therefore of the data to be decoded. The processing of the symbol 4 thus becomes easier.
the composition (with the second recessed elements/boss elements) of the light parts 41 of the coded matrix symbol 4 also makes it possible to improve their contrast with the dark parts 40.

1. A tire made of rubbery material comprising a sidewall, wherein the sidewall comprises a coded matrix symbol, the said coded matrix symbol comprising dark parts and light parts, the dark parts being made up of a texture formed as an integral part of said sidewall and contrasting against the rest of the tire, said texture being an organized arrangement of a plurality of elements.

2. The tire according to claim 1, wherein the coded matrix symbol is a symbol selected from a collection of symbols comprising:
a data matrix™
a QR™;
a QR code™;
a MaxiCode™;
a PDF-417™;
a code 16K™;
a code 49™,
an Aztec code™.

3. The tire according to claim 1, wherein the texture comprises a plurality of protruding elements or a plurality of first recessed elements set back from the surface of the sidewall.

4. The tire according to claim 3, wherein all or some of the protruding elements are strands distributed through the texture with a density at least equal to one strand per square millimetre (mm²), each strand having a mean cross section of between 0.0005 mm² and 1 mm².

5. The tire according to claim 3, wherein all or some of the protruding elements are substantially mutually parallel lamellae, the spacing of the lamellae in the texture being at most equal to 0.5 mm, each lamella having a mean width of between 0.02 mm and 0.25 mm.

6. The tire according to claim 3, wherein all or some of the protruding elements form parallelepipeds of a side length of between 0.05 mm and 0.5 mm, of a height of between 0.05 mm and 0.5 mm, the distance between two adjacent parallelepipeds in the texture being between 0.05 mm and 0.5 mm.

7. The tire according to claim 3, wherein the first recessed elements form openings on the surface of the sidewall and the texture comprises a plurality of openings, these openings being distributed through the texture at a density at least equal to one opening per square millimetre (mm²), these openings having equivalent diameters of between 0.01 mm and 1.2 mm.

8. The tire according to claim 1, wherein the light parts of the coded matrix symbol are made up of a pattern comprising a plurality of second recessed elements and/or of boss elements, each recessed element/boss element having the shape of part of a sphere.

9. The tire according to claim 8, wherein the second recessed elements are connected to one another at connection zones which extend above the mean surface of the sidewall.

10. The tire according to claim 8, wherein, when viewed in cross section, all or some of the second recessed elements/boss elements have an angular extent less than or equal to 70°.

11. The tire according to claim 8, wherein in the pattern, a second recessed element is positioned to alternate with a boss element, the light parts of the coded matrix symbol exhibiting, in this alternation, a variation in curvature of the cosine or sine type.

12. The tire according to claim 1, wherein the light parts of the coded matrix symbol comprise a surface roughness of parameter Ra less than 30 μm.

13. The tire according to claim 1, wherein the coded matrix symbol is surrounded by a textured zone at least 2 mm in width formed integrally with the sidewall and contrasting with the rest of the tire.

14. The tire according to claim 1, wherein the coded matrix symbol follows a curvature of the sidewall of the tire.

15. The tire according to claim 1, wherein the coded matrix symbol is set back into the sidewall of the tire.
